(19) United States
(12) Patent Application Publication
(10) Pub. No.: US 2026/0286546 A1
(43) Pub. Date: Sep. 24, 2026

(54) ELECTROCHEMICAL STACK AND MOUNTING ASSEMBLY FOR A STACK OF THIS TYPE

(71) Applicant: Robert Bosch GmbH, Stuttgart (DE)

(72) Inventors: Sebastian Poersch, Ditzingen (DE); Lars Neher, Asperg (DE)

(21) Appl. No.: 19/478,100

(22) PCT Filed: Apr. 16, 2024
(86) PCT No.: PCT/EP2024/060277

§ 371 Date: Nov. 24, 2025

(30) Foreign Application Priority Data
Apr. 24, 2023 (DE) 10 2023 203 721.1

(51) Int. Cl. C25B 9/70

(52) U.S. Cl. CPC C25B 9/70

(57) ABSTRACT

Electrochemical stack (1) comprising a plurality of electrochemical cells (2) that are oriented horizontally and arranged between a top plate (4) and a bottom plate (3) of the stack (1), wherein the top plate (4) and the bottom plate (3) are tensioned against one another by a tensioning device (5). At least one port is configured on the top plate (4) for supplying or discharging gaseous and/or liquid media to or from the electrochemical cells (2). The top plate (4) comprises suspension elements (17) configured to fasten the electrochemical stack (1) to a frame structure (15), wherein the bottom plate (3) is freely suspended. The mounting assembly for mounting the electrochemical stack comprises a frame structure (15) on which the electrochemical stack (1) rests with its suspension elements (17), such that the bottom plate (3) is freely suspended and the electrochemical cells (2) are oriented horizontally.

### BACKGROUND

The invention relates to an electrochemical stack, such as may be used, for example, to generate electrical power from chemical energy or to produce hydrogen and oxygen using electrical power, and to a mounting assembly for mounting a stack of this type.

Electrochemical stacks have various fields of application. For example, they are used as fuel cells for generating electrical power from chemical energy, or, in the reverse application, as electrolyzers for producing hydrogen and oxygen by electrochemical splitting with the aid of electric current. The hydrogen may then be converted back into electrical power at a later time, or it serves as a starting material for other chemical processes. Typically, the electrochemical stacks comprise a plurality of electrochemical cells in which the actual reaction takes place. In simplified terms, the electrochemical cells consist of an anode compartment and a cathode compartment, which are separated from one another by a semipermeable membrane coated with electrodes. The cathode and anode compartments are filled with or passed through by liquids, in particular water, or by gas when the stack is in operation.

In an electrolyzer, a direct voltage is applied between the electrodes, thereby splitting the water present in the anode compartment and causing the hydrogen to diffuse into the cathode compartment. The membrane surface area is determinative for the amount of hydrogen produced. In order to achieve the highest possible yield, the individual electrochemical cells are configured to be very flat, such that a large number of such cells may be stacked one above another and the total membrane area is correspondingly large. Via channels running perpendicular to the electrochemical cells, all cells are supplied with water and the resulting gases are discharged via further channels. To ensure sealing integrity of the cells, the cell stack is positioned between a bottom plate and a top plate that are held together under high tension. For example, the required tensioning device consists of a plurality of tensioning bolts arranged around the circumference of the cell stack, or of tensioning straps.

During operation, water and gases, for example, hydrogen or air, must be supplied to the electrochemical cells, and the gases formed as well as the unconsumed water must be discharged again. If required, cooling water is additionally supplied and discharged. For this purpose, the electrochemical stack must comprise corresponding ports, which are preferably located on the top plate where they are easily accessible. The stack is positioned with its bottom plate on a mounting fixture.

When the stack is in operation, heat is generated and thermal expansion occurs. As a result, the distance between the bottom plate and the top plate changes, which, in larger stacks comprising several hundred electrochemical cells, may increase by a few millimeters. Therefore, the supply lines on the top plate must comprise compensating elements to prevent damage resulting from the upward and downward movement of the top plate relative to the base.

### SUMMARY

By contrast, the electrochemical stack according to the invention has the advantage that the stack may be operated at its upper end, that is, at the top plate, with the ports required for operation, wherein either no compensating elements are required in the supply lines to compensate for the thermal expansion of the stack, or only very simple and therefore cost-effective ones. The electrochemical stack comprises a plurality of electrochemical cells that are oriented horizontally and are arranged between a top plate and a bottom plate of the stack, wherein the top plate and the bottom plate are tensioned against one another by a tensioning device. At least one port is configured on the top plate for supplying or discharging gaseous and/or liquid media to or from the electrochemical cells. The top plate comprises suspension elements configured to fasten the electrochemical stack to a frame structure, wherein the bottom plate is freely suspended.

The electrochemical stack according to the invention may be suspended from the suspension elements in a corresponding frame structure, such that the bottom plate does not come into contact with the base. When the stack expands due to heating in operation, the distance between the top plate and the base remains constant, while the bottom plate moves slightly in the direction of the base to the extent that the stack expands. Since the top plate is always at the same height above the base, the supply and discharge lines may be fastened there without compensating elements, which results in a considerable saving, particularly in large and high-performance electrolyzers or fuel cells, as the lines in such systems have large cross-sections and wall thicknesses and are therefore inflexible.

In a first advantageous embodiment, the suspension elements are configured on the outer edge of the top plate. Preferably, the suspension elements are arranged distributed across the width of the top plate, in order to achieve a uniform distribution of the stack weight over the individual suspension elements and the frame structure. Electrochemical stacks typically have a high weight, which may exceed one ton. Uneven loading of the stack in the suspension must be strictly avoided, as this may lead, at least in the long term, to a loss of sealing integrity between the electrochemical cells.

In order not to impair the uniform distribution of water in the electrochemical cells, it is furthermore advantageous if the suspension elements are arranged in a plane that is oriented parallel to the electrochemical cells. This supports the uniform distribution of water in the electrochemical cells, thereby preventing premature wear.

Advantageously, the suspension elements are configured as bolts that project laterally from the top plate. Bolts are capable of absorbing large forces and are easy to install. Alternatively, the suspension elements may be configured as metal rails that are preferably fastened on opposite sides of the top plate. These rest flat on the frame structure and may be fastened there in a simple manner, for example, by a screw connection.

The mounting assembly according to the invention comprises an electrochemical stack and a frame structure on which the electrochemical stack rests with its suspension elements, such that the bottom plate is freely suspended. In this way, the stack may expand without difficulty in operation under the unavoidable heating, without the ports for the required liquids and gases being subjected to mechanical stress. Advantageously, the frame structure is prepared to be connected to the suspension elements in order to establish a mechanically stable connection with the electrochemical stack, and to securely hold it in the desired position.

### BRIEF DESCRIPTION OF THE DRAWINGS

In the drawing, an electrochemical stack according to the invention and a mounting fixture for this stack are shown. It shows

FIG. 1 a mounting fixture with two stacks in a perspective view,

FIG. 2 an enlarged detail of FIG. 1 in the region of the suspension,

FIG. 3 a side view of the mounting assembly according to FIG. 1,

FIG. 4 a further mounting fixture with one stack and a second embodiment of the suspension,

FIG. 5 a detailed view of the mounting fixture of FIG. 4, and

FIG. 6 a detailed view of a further mounting fixture similar to FIG. 5.

### DETAILED DESCRIPTION

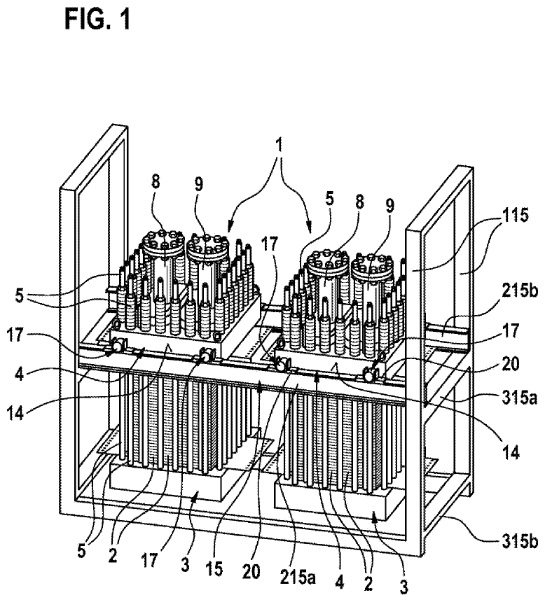

FIG. 1 shows two electrochemical stacks 1 according to the invention in a mounting position. Each electrochemical stack 1 comprises a plurality of electrochemical cells 2 that are stacked on top of one another. The individual electrochemical cells 2 are configured flat, and are typically only a few millimeters thick, such that a stack 1 may comprise several hundred cells 2. The electrochemical cells 2 are arranged between a bottom plate 3 and a top plate 4, which form the lower and upper ends, respectively, of the stack 1. The bottom plate 3 and the top plate 4 are pressed against one another by a plurality of tensioning bolts 5 in order to seal the electrochemical cells 2 against one another and against the outside. The tensioning bolts 5 are arranged distributed around the circumference of the bottom plate 3 and the top plate 4 in order to achieve a uniform contact pressure. Both the bottom plate 3 and the top plate 4 are manufactured stably from a metallic material, since high contact forces are typically required, which are intended to act as uniformly as possible over the entire cross-section of the electrochemical cells 2. To supply the liquids and gases required in the operation of the electrochemical cells 2, two ports 8, 9 are mounted on the top plate 4. The water or other liquid is supplied to all cells 2 via channels that extend vertically through the electrochemical stack 1. The resulting gases or liquids are directed via additional channels and are treated or removed outside the electrochemical stack 1.

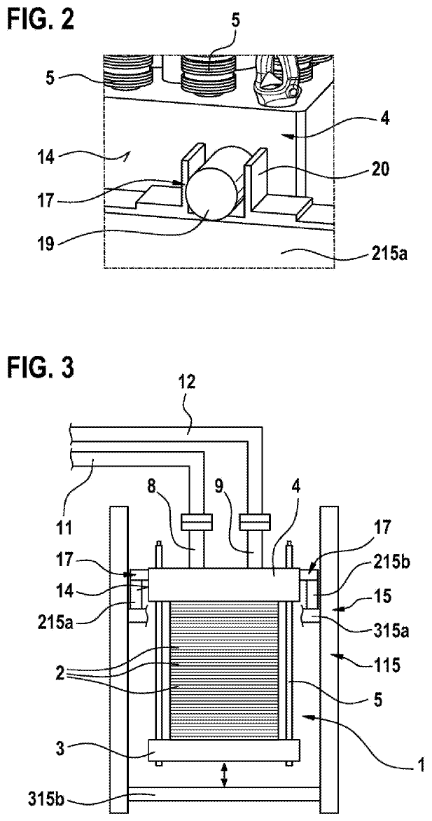

The two electrochemical stacks 1 are suspended in a frame structure 15. The frame structure 15 comprises four vertical struts 115, which are fixedly connected to an upper cross strut 315a and a lower cross strut 315b and further to a front longitudinal strut 215a and a rear longitudinal strut 215b, for example, by welded or screw connections. The electrochemical stacks 1 are suspended in the frame structure 15. For this purpose, two suspension elements 14 in the form of bolts 19 are mounted on the edge 14 of the top plate 4, on the front side and on the opposite rear side, respectively, the bolts resting on the front longitudinal strut 215a and the rear longitudinal strut 215b, respectively. As shown again in the enlarged view of FIG. 2, the bolts 19 are each suspended in a fork-shaped receptacle 20, such that the electrochemical stack 1 does not slip but may easily be lifted upward out of the frame structure 15 when required. For this purpose, the receptacles 20 are fixedly connected to the front longitudinal strut 215a and the rear longitudinal strut 215b, respectively, for example, by a welded connection.

FIG. 3 shows a top view of the narrow side of the frame structure 15 with the electrochemical stack 1. The ports 8, 9 on the top plate 4 are connected to lines 11, 12, via which the required water or gases are supplied and discharged. In the operation of the electrochemical stack 1, which may be, for example, an electrolyzer for generating hydrogen and oxygen from water, the stack 1 heats up significantly. As a result, the electrochemical cells 2, and thus the entire stack 1, expand, which may cause the bottom plate 3 to move downward by several millimeters due to the large number of cells 2, as indicated by the arrow in FIG. 3. However, since the stack 1 is held exclusively on the bolts 19 that are connected to the top plate 4, the top plate 4 does not move vertically relative to the frame structure 15. As a result, the lines 11, 12 may be rigidly connected to the electrochemical stack 1 without the need for compensating elements to offset a change in height.

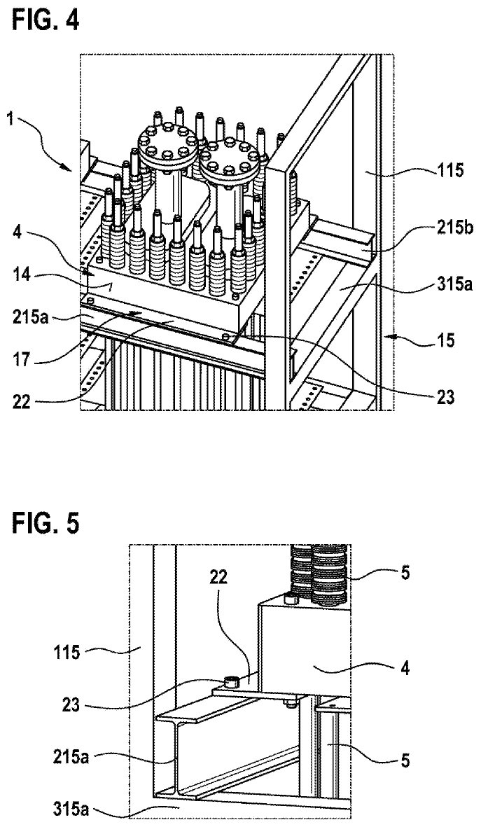

FIG. 4 shows a further exemplary embodiment of the electrochemical stack 1 according to the invention, and its mounting in the frame structure 15. Instead of the bolts 19, a rail 22 is mounted on the front side and on the rear side of the top plate 4, respectively, which forms the suspension 14. The rails 22 are connected to the longitudinal struts 215a, 215b by a plurality of screws 23 in order to fix the stack 1 in the frame structure 15, as shown in an enlarged view in FIG. 5. The rails 22 distribute the weight of the stack 1 more uniformly on the frame structure 15, which may improve stability.

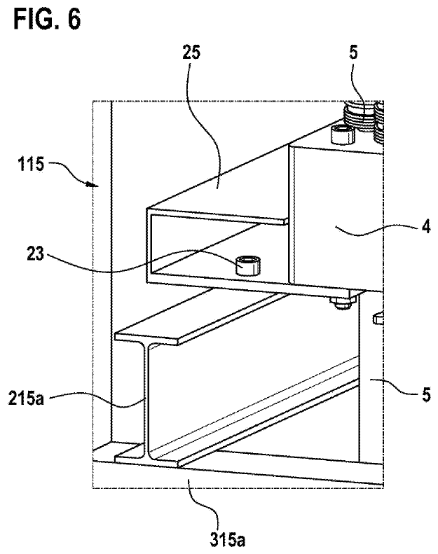

FIG. 6 shows a further exemplary embodiment for mounting the stack 1 on the frame structure 15. Instead of the rails 22, as shown in FIG. 5, a forklift rail 25 is mounted on the front side and on the rear side of the stack 1, respectively. Said forklift rail consists of a hollow profile that is dimensioned such that a fork tine of a forklift may be inserted therein in order to transport the stack 1, to lift it into the frame structure 15, or to remove it therefrom. For fixation, screws 23 are also provided here, the screw heads of which are arranged inside the forklift rail 25.

1. An electrochemical stack (1) comprising:
a plurality of electrochemical cells (2) that are oriented horizontally and are arranged between a top plate (4) and a bottom plate (3) of the stack (1), wherein the top plate (4) and the bottom plate (3) are tensioned against one another by a tensioning device (5) and are parallel to one another, and comprising at least one port for supplying or discharging gaseous or liquid media to or from the electrochemical cells (2), wherein the port is configured in the top plate (4),
wherein,
the top plate (4) comprises suspension elements (17) that are configured to fasten the electrochemical stack (1) to a frame structure (15), wherein the bottom plate (3) is freely suspended.

2. The electrochemical stack according to claim 1, wherein the suspension elements (17) are configured at an outer edge (14) of the top plate (4).

3. The electrochemical stack according to claim 2, wherein a plurality of suspension elements (17) are arranged distributed around a circumference of the top plate (4) at the outer edge (14) of the top plate (4).

4. The electrochemical stack according to claim 3, wherein the suspension elements (17) lie in a single plane.

5. The electrochemical stack according to claim 4, wherein the plane is oriented parallel to the electrochemical cells (2).

6. The electrochemical stack according to claim 1, wherein the suspension elements (17) are configured as bolts (19) that project laterally from the top plate (4).

7. The electrochemical stack according to claim 1, wherein the suspension elements (17) are configured as metal rails (22).

8. The electrochemical stack according to claim 7, wherein a metal rail (22) is arranged on two opposite sides of the top plate (4).

9. A mounting assembly for mounting an electrochemical stack according to claim 1, comprising a frame structure (15) on which the electrochemical stack (1) rests with its suspension elements (17), such that the bottom plate (3) is freely suspended and the electrochemical cells (2) are oriented horizontally.

10. The mounting assembly according to claim 9, wherein the suspension elements (17) are screwed to the frame structure (15).

11. The mounting assembly according to claim 9, wherein the suspension elements (17) are in the form of bolts (19), and that receptacles (20) for said bolts (19) are configured on the frame structure (15).
